(19) United States
(12) Patent Application Publication
(10) Pub. No.: US 2002/0143912 A1
(43) Pub. Date: Oct. 3, 2002

(54) Method of previewing content in a distributed communications system

(75) Inventors: Joseph L. Michels, Scottsdale, AZ (US); Michael Bordelon, Phoenix, AZ (US); Kevin D. Wills, Chandler, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/823,117

(22) Filed: Apr. 2, 2001

(51) Int. Cl. G06F 15/16; G06F 15/173

(52) U.S. Cl. 709/223; 709/201

(57) ABSTRACT

A method of previewing content in a distributed communications system (100) includes receiving categorized content (210) at a remote communications node (104). The categorized content (210) is then evaluated and assigned contextual audio content (220). The categorized content (210) is then previewed utilizing the contextual audio content (220). Contextual audio content (220) can be user-provided and user-defined in order to enrich the distributed communications system (100) environment.

### FIELD OF THE INVENTION

This invention relates generally to providing content in a distributed communications system and, in particular to a method of previewing content in a distributed communications system.

### BACKGROUND OF THE INVENTION

The use of in-vehicle, Internet capable devices are currently being implemented and will become ubiquitous in the future. However, the use of such devices in vehicles can be potentially distracting to a user. Currently, such devices have interface elements that include a viewing screen, a variety of buttons and speakers. In order to preview content and take advantage of the wide array of offerings through these devices, a user is often required to look at the viewing screen and select content by pressing buttons, and the like. Other methods such as text-to-speech (TTS) are also available, however some interaction with the viewing screen and buttons is still required. The selection of content and the interaction with the in-vehicle device can be distracting to the vehicle driver and lessen the value of having such devices and capabilities readily available to vehicle users.

Accordingly, there is a significant need for methods of previewing content in a distributed communications system that overcomes the deficiencies of the prior art outlined above.

### BRIEF DESCRIPTION OF THE DRAWINGS

Referring to the drawing:

FIG. 1 depicts an exemplary distributed communications system, according to one embodiment of the invention;

FIG. 2 depicts a table illustrating exemplary categorized content and corresponding contextual audio content, according to one embodiment of the invention; and

FIG. 3 shows a flow chart of a method of previewing categorized content, according to one embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

The present invention is a method of previewing content in a distributed communications system with software components running on mobile client platforms and on remote server platforms. To provide an example of one context in which the present invention may be used, an example of a method of previewing content will now be described. The present invention is not limited to implementation by any particular set of elements, and the description herein is merely representational of one embodiment. The specifics of one or more embodiments of the invention are provided below in sufficient detail to enable one of ordinary skill in the art to understand and practice the present invention.

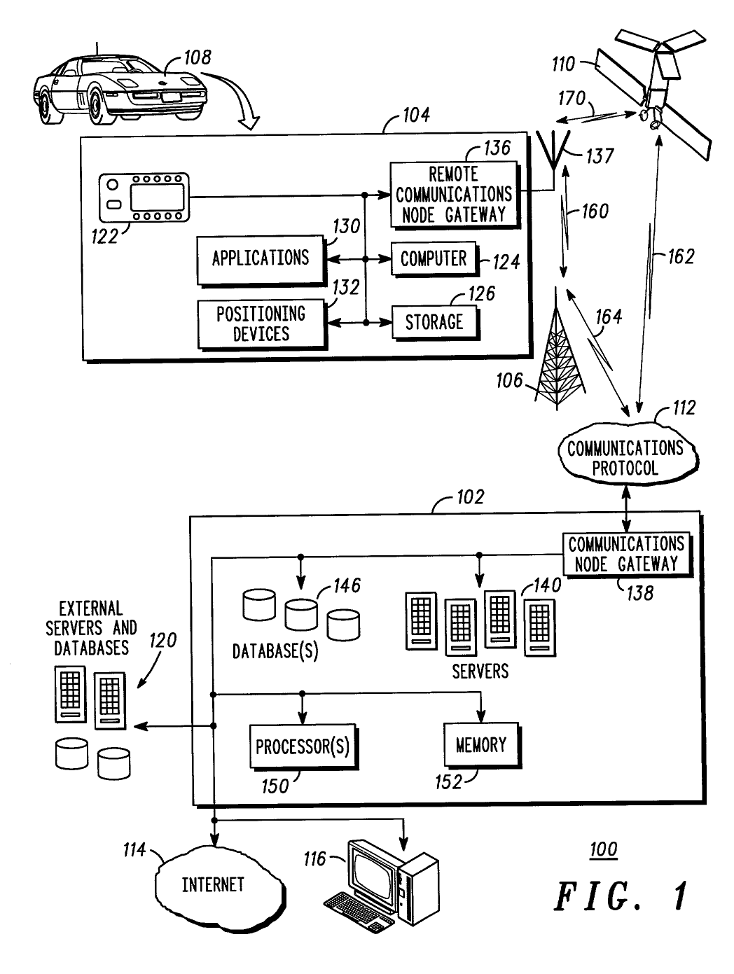

FIG. 1 depicts an exemplary distributed communications system 100 according to one embodiment of the invention. Shown in FIG. 1 are examples of components of a distributed communications system 100, which comprises among other things, a communications node 102 coupled to a remote communications node 104. The communications node 102 and remote communications node 104 can be coupled via a communications protocol 112 that can include standard cellular network protocols such as GSM, TDMA, CDMA, and the like. Communications protocol 112 can also include standard TCP/IP communications equipment. The communications node 102 is designed to provide wireless access to remote communications node 104, to enhance regular video and audio broadcasts with extended video and audio content, and provide personalized broadcast, information and applications to the remote communications node 104.

Communications node 102 can also serve as an Internet Service Provider to remote communications node 104 through various forms of wireless transmission. In the embodiment shown in FIG. 1, communications protocol 112 is coupled to one or more local nodes 106 by a wireline or wireless link 164. Communications protocol 112 is also capable of communication with satellite 110 via wireless link 162. Content can be further communicated to remote communications node 104 from one or more local nodes 106 via wireless link 160, or from satellite 110 via wireless link 170. Wireless communication can take place using a cellular network, FM sub-carriers, satellite networks, and the like. The components of distributed communications system 100 shown in FIG. 1 are not limiting, and other configurations and components that form distributed communications system 100 are within the scope of the invention.

Remote communications node 104 without limitation can include a wireless unit such as a hand-held computing device such as a personal digital assistant (PDA) or Web appliance, or any other type of communications and/or computing device. Without limitation, one or more remote communications nodes 104 can be contained within, and optionally form an integral part of a vehicle 108, such as a car, truck, bus, train, aircraft, or boat, or any type of structure, such as a house, office, school, commercial establishment, and the like. Remote communications node 104 can also be implemented in a device that can be carried by the user of the distributed communications system 100.

Communications node 102 can also be coupled to other communications nodes (not shown for clarity), and the Internet 114, which includes any Internet web servers. In addition, communications node 102 can be coupled to external severs and databases 120. Users of distributed communications system 100 can create user-profiles and configure/personalize their user-profile, enter data, and the like through a user configuration device 116, such as a computer. Other user configuration devices 116 are within the scope of the invention and can include a telephone, pager, PDA, Web appliance, and the like. User-profiles and other configuration data is preferably sent to communications node 102 through a user configuration device 116, such as a computer with an Internet connection 114 using a web browser as shown in FIG. 1. For example, a user can log onto the Internet 114 in a manner generally known in the art and then access a configuration web page of the communications node 102. Once the user has configured the web page selections as desired, he/she can submit the changes. The new configuration, data, preferences, and the like, including an updated user-profile, can then be transmitted to remote communications node 104 from communications node 102.

As shown in FIG. 1, communications node 102 can comprise a communications node gateway 138 coupled to various servers 140, databases 146, software blocks (not shown for clarity) and the like. Servers 140 can include, for example, wireless session servers, content converters, central gateway servers, personal information servers, application specific servers, and the like. Databases 146 can include, for example, customer databases, broadcaster databases, advertiser databases, user-profile databases, and the like. Servers 140 can send and receive content data from external servers and databases 120 such as traffic reports, weather reports, news, and the like, in addition to content data already stored at communications node 102. Communications node 102 also includes one or more processors 150 and memory 152. Processors 150 and memory 152 can be separate or an integral part of servers 140. Memory comprises control algorithms, and can include, but is not limited to, random access memory (RAM), read only memory (ROM), flash memory, and other memory such as a hard disk, floppy disk, and/or other appropriate type of memory.

Communications node 102 can initiate and perform communications with remote communication nodes 104, user configuration devices 116, and the like, shown in FIG. 1 in accordance with suitable computer programs, such as control algorithms stored in memory. Servers 140 in communications node 102, while illustrated as coupled to communications node 102, could be implemented at any hierarchical level(s) within distributed communications system 100. For example, servers 140 could also be implemented within other communication nodes, local nodes 106, the Internet 114, and the like.

Communications node gateway 138 is coupled to remote communications node gateway 136 via antenna 137. Remote communications node gateway 136 is coupled to various applications 130, which can include, without limitation, navigation applications, traffic applications, entertainment applications, business applications, and the like. Applications 130 are coupled to, and can process data received from internal and external positioning device(s) 134.

Remote communications node 104 comprises a user interface device 122 comprising various human interface (H/I) elements such as a display, a multi-position controller, one or more control knobs, one or more indicators such as bulbs or light emitting diodes (LEDs), one or more control buttons, one or more speakers, a microphone, and any other H/I elements required by the particular applications to be utilized in conjunction with remote communications node 104. User interface device 122 is coupled to applications 130 and can request and display content including, navigation content, sound and video content, and the like. The invention is not limited by the user interface device 122 or the (H/I) elements depicted in FIG. 1. As those skilled in the art will appreciate, the user interface device 122 and (H/I) elements outlined above are meant to be representative and to not reflect all possible user interface devices or (H/I) elements that may be employed.

As shown in FIG. 1, remote communications node 104 comprises a computer 124, preferably having a microprocessor and memory, and storage devices 126 that contain and run an operating system and applications to control and communicate with onboard peripherals.

Remote communications node 104 can optionally contain and control one or more digital storage devices 126 to which real-time broadcasts and audio/video data can be digitally recorded. The storage devices 126 may be hard drives, flash disks, or other storage media. The same storage devices 126 can also preferably store digital data that is wirelessly transferred to remote communications node 104 in faster than real-time mode.

In FIG. 1, communications node 102 and remote communications node 104, perform distributed, yet coordinated, control functions within distributed communications system 100. Elements in communications node 102 and elements in remote communications node 104 are merely representative, and distributed communications system 100 can comprise many more of these elements within other communications nodes and remote communications nodes.

Software blocks that perform embodiments of the invention are part of computer program modules comprising computer instructions, such control algorithms, that are stored in a computer-readable medium such as memory described above. Computer instructions can instruct processors to perform methods of operating communications node 102 and remote communications node 104. In other embodiments, additional modules could be provided as needed.

The particular elements of the distributed communications system 100, including the elements of the data processing systems, are not limited to those shown and described, and they can take any form that will implement the functions of the invention herein described.

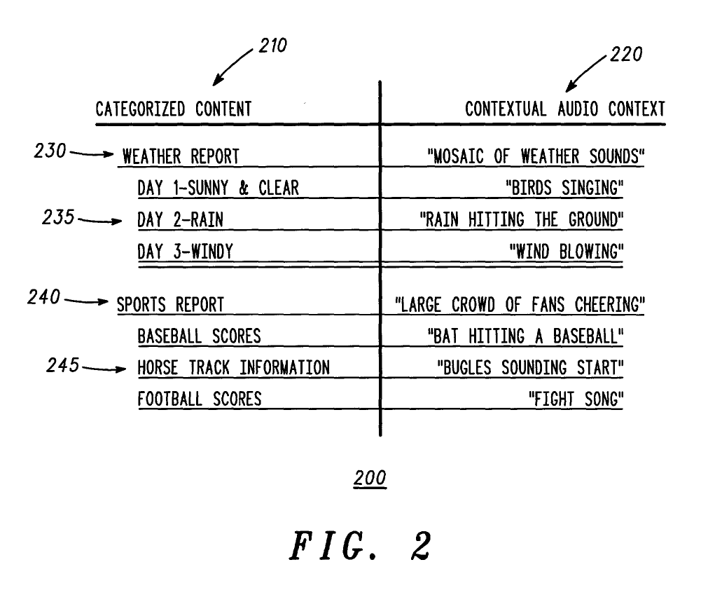

FIG. 2 depicts a table 200 illustrating exemplary categorized content 210 and corresponding contextual audio content 220, according to one embodiment of the invention. Categorized content 210 can be content that is requested by a user or automatically communicated to remote communications node 104. In an embodiment of the invention, contextual audio content 220 is associated with categorized content 210 so that categorized content 210 can be previewed by a user utilizing contextual audio content 220.

Categorized content 210 can be, for example and without limitation, weather reports, news, sports, stocks, navigation data, point-of-interest data, and the like. Categorized content 210 can take the form of audio, video, text-to-speech (TTS), and the like. In an embodiment of the invention, categorized content 210 is communicated to a user via user interface device 122 of remote communications node 104.

Categorized content 210 can also contain sub-categorized content, which can be subcategories of content under the same general category as categorized content 210. Any number of hierarchical levels of sub-categorized content is within the scope of the invention. For example, rows 235 are all sub-categorized content of categorized content 230 “weather report.” As another example, rows 245 are all sub-categorized content of categorized content 240 “sports report.” Each of sub-categorized content 235, 245 can have associated contextual audio content 220. For example, categorized content 210 “weather report” has sub-categorized content 235, which represents weather forecasts for three consecutive days. “Day 1—Sunny & clear” has associated textual audio content of “birds singing.” “Day 2—Rain” has associated textual content of “rain hitting the ground.” “Day 3—windy” has associated textual content of “wind blowing.” Similar exemplary sub-categorized content 245 and associated contextual audio content 220 is shown for categorized content 240 “sports report.” The categorized content 210, subcategorized content 235, 245, and associated contextual audio content 220 are examples and not meant to be limiting of the invention. Any categorized content, sub-categorized content and associated contextual audio content are within the scope of the invention.

Contextual audio content 220 can be, for example and without limitation, any audio content that conforms to the context of its corresponding categorized content 210. For example, in FIG. 2, row 230 represents categorized content 210 “weather report” 230 and its corresponding contextual audio content 220 of a “mosaic of weather sound,” which can include, for example, any mixture of “weather sounds.” These can include, without limitation, a mixture of “birds singing,” “wind blowing,” and the like. As another example, row 240 includes categorized content 210 “sports report” and its corresponding contextual audio content 220 of “large crowd of fans cheering.” Contextual audio content 220 is not merely an audio file, but audio content that captures the “essence” of the categorized content 210 that will follow, allowing a user to preview the categorized content that will follow and essentially know the “essence” or “bulk” of what the forthcoming content will contain.

Contextual audio content 220 can be in any number of encoded audio formats including, but not limited to ADPCM (adaptive differential pulse-code modulation); CDDA (compact disc-digital audio) digital audio specification; and ITU (International Telecommunications Union) Standards G.711, G.722, G.723 & G.728, MP3, AC-3, AIFF, AIFC, AU, Pure Voice, Real Audio, WAV, and the like. Contextual audio content 220 can be recorded audio content, streaming audio content, broadcast audio content, and the like.

In operation, contextual audio content 220 is utilized to preview categorized and sub-categorized content 210, 235, 245. As categorized content 210 becomes available to a user on remote communications node 104, contextual audio content 220 is utilized to link a user's understanding of the forthcoming categorized content 210 so that the user does not have to manually interact with a user interface device 122 by looking at a viewing screen, talking or pressing buttons. The contextual audio content 220 foreshadows and previews the categorized content 210 that will follow by playing contextual audio content 220 that is in the same context as the forthcoming categorized content 210.

Contextual audio content 220 for various categorized content 210 can be automatically supplied by administrators of distributed communications system 100 or by a user of distributed communications system. For example, a user can log onto the Internet 114 using a web browser and user configuration device 116 as shown in FIG. 1. The user can access a configuration web page for his/her account in distributed communications system 100. From the configuration web page the user can set up and modify his/her preferences including adding, deleting, and the like, contextual audio content 220 to his/her profile. For example, instead of the default contextual audio content 220 provided, a user can configure the account with his/her preferences for contextual audio content associated with certain categorized content 210. In effect, the user can both provide and define the contextual audio content 220 utilized by distributed communications system 100. The contextual audio content 220 is saved on databases 146 at communications node 102 and implemented by servers 140, processors 150, and the like. Contextual audio content 220 can be communicated to remote communications node 104 at remote communications node 104 start-up, communicated prior to remote corresponding categorized content 210, stored in remote communications node 104, and the like. In another embodiment of the invention, contextual audio content 220 can be placed in a general sharing file in communications node 102 for access by other users in configuring their profiles.

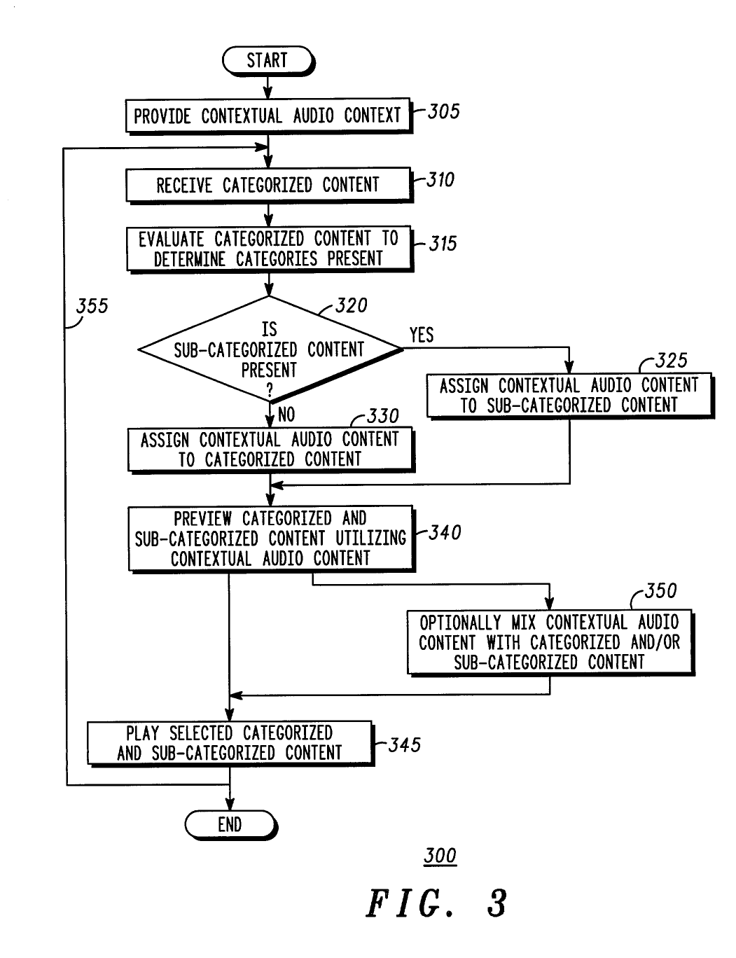

FIG. 3 shows a flow chart 300 of a method of previewing categorized content 210, according to one embodiment of the invention. In step 305, contextual audio content 220 is provided by any of the methods discussed above, including being user-provided or user-defined. In step 310, a plurality of categorized content 210 is received at remote communications node 104. Categorized content 210 is communicated from communications node 102 and can either be automatic or user-requested.

In step 315, plurality of categorized content 210 is evaluated to determine the proper categories for subsequent assignment of contextual audio content 220. As an example of an implementation of the evaluation step, each of the plurality of categorized content 210 can have a “tag” or other identifier associated with it, which is associated with a particular category of content. The “tag” can then be used to match or assign the proper contextual audio content 220 with a similar “tag.” In this manner, categorized content 210 is placed in a particular category, for example, “weather,” “sports,” and the like. Sub-categorized content 235, 245 can be organized using a similar methodology. In another example, algorithms to parse categorized content 210, especially categorized textual content, can be utilized to assign the proper contextual audio content 220. One skilled in the art will recognized that there are many possible methods to implement the categorizing of content and the method disclosed here is not meant to be limiting. The invention encompasses any method of evaluating and categorizing content.

In step 320, it is determined if categorized content 210 contains sub-categorized content 235, 245. If the decision step in 320 indicates that sub-categorized content 235, 245 is present, contextual audio content 220 is assigned per step 325. If no sub-categorized content 235, 245 is present, contextual audio content 220 is assigned to categorized content 210 per step 330. It should be understood that both categorized and sub-categorized content 210, 235, 245 can be present, so that both steps 325 and 330 can be executed simultaneously for content that is received by remote communications node 104. Any number of hierarchical levels of sub-categorized content 235, 245 can be included with the corresponding step to determine if sub-categorized content 235, 245 is present, along with the assignment of appropriate contextual audio content 220. In one embodiment, contextual audio content 220 is assigned to both categorized and sub-categorized content 210, 235, 245.

In step 340, categorized and sub-categorized content 210, 235, 245 is previewed utilizing contextual audio content 220 assigned respectively. In effect, contextual audio content 220 will foreshadow the categorized content 210 that will follow and allow the user to know what type of categorized and sub-categorized content 210, 235, 245 will be next if he/she remains on the same channel or continues to receive the same categorized content 210 on remote communications node 104. In an embodiment of the invention, the contextual audio content 220 allows a user to know what categorized or sub-categorized content 210, 235, 245 is upcoming or available without having take his/her eyes off of the road or interact directly with user interface device 122 of remote communications node 104. The contextual audio content 220 also offers the advantage of “enlivening” or “adding color” to monotone TTS streaming channels and content received through remote communications node 104.

In step 345, categorized content 210 and sub-categorized content 235, 245 that has been previewed or selected is then played for the user of remote communications node 104. Optionally, in step 350, contextual audio content 220 is mixed with categorized and subcategorized content 210, 235, 245. In one embodiment, contextual audio content 220 can be played to preview each piece of categorized and sub-categorized content 210, 235, 245. For example, as the “sports report” categorized content 240 in FIG. 2 is played, contextual audio content 220 for each of the sub-categorized content 245 can play before each of the subcategorized content 245 plays. In effect, contextual audio content 220 plays prior to each sports score in rapid succession. This has the advantage of previewing each successive section of categorized 210 and subcategorized content 235, 245 signaling to the user what is coming next. In another embodiment, contextual audio content can be mixed with categorized 210 and sub-categorized content 235, 245 as the respective contents are actually playing. While the contextual audio content 220 is playing at a reduced level in the background the content, for example, TTS, is playing in the foreground. This again has the advantage of “enlivening” normally monotone TTS thereby capturing or maintaining a user's interest. The process of previewing and then playing categorized content 210 and sub-categorized content 235, 245 can be repeated as often as necessary as depicted by the return arrow 355.

While we have shown and described specific embodiments of the present invention, further modifications and improvements will occur to those skilled in the art. We desire it to be understood, therefore, that this invention is not limited to the particular forms shown and we intend in the appended claims to cover all modifications that do not depart from the spirit and scope of this invention.

1. A method of previewing content in a distributed communications system comprising:
receiving a plurality of categorized content at a remote communications node;
evaluating each of the categorized content;
assigning contextual audio content to each of the categorized content; and
previewing the categorized content utilizing the contextual audio content.

2. The method of claim 1, further comprising mixing the contextual audio content with the categorized content.

3. The method of claim 1, wherein the categorized content comprises subcategorized content, and wherein assigning the contextual audio content comprises assigning the contextual audio content to each of the sub-categorized content.

4. The method of claim 3, further comprising previewing the sub-categorized content utilizing the contextual audio content.

5. The method of claim 1, wherein receiving the plurality of categorized content comprises receiving categorized textual content.

6. The method of claim 1, wherein the contextual audio content is user-provided.

7. The method of claim 1, wherein the contextual audio content is user-defined.

8. A computer-readable medium containing computer instructions for instructing a processor to perform a method of previewing content in a distributed communications system, the instructions comprising:
receiving a plurality of categorized content at a remote communications node;
evaluating each of the categorized content;
assigning contextual audio content to each of the categorized content; and
previewing the categorized content utilizing the contextual audio content.

9. The computer-readable medium in claim 8, the instructions further comprising mixing the contextual audio content with the categorized content.

10. The computer-readable medium in claim 8, wherein the categorized content comprises sub-categorized content, and wherein assigning the contextual audio content comprises assigning the contextual audio content to each of the sub-categorized content.

11. The computer-readable medium in claim 10, the instructions further comprising previewing the sub-categorized content utilizing the contextual audio content.

12. The computer-readable medium in claim 8, wherein receiving the plurality of categorized content comprises receiving categorized textual content.

13. The computer-readable medium in claim 8, wherein the contextual audio content is user provided.

14. The computer-readable medium in claim 8, wherein the contextual audio content is user-defined.
